(19) United States
(12) Patent Application Publication
(10) Pub. No.: US 2006/0106780 A1
(43) Pub. Date: May 18, 2006

(54) Method for improving user success rates in personals sites

(76) Inventor: Ofer Dagan, Southbury, CT (US)

Correspondence Address: Ofer Dagan, 208 Jacqueline Drive, Southbury, CT, 06488, US

(21) Appl. No.: 11/257,212

(22) Filed: Oct. 24, 2005

Related U.S. Application Data
(60) Provisional application No. 60/621,817, filed on Oct. 25, 2004.

(51) Int. Cl. G06F 17/30

(52) U.S. Cl. 707/3; 707/104.1

(57) ABSTRACT

Numerous online dating and personals websites exist on the internet. These websites allow users to post online profiles describing what they seek in a “match,” provide methods by which users may interact with each other, and may implement an “active matching process” in which the websites attempt to select potential matches for the searching user. These websites generally lack the spontaneity of live networking or matchmaker events and also lack the atmosphere provided by live conversation. For this reason, users of these websites may find that potential matches are not as desirable as initially perceived because of the “chemistry” between two people who interact in a live setting. The invention described and claimed herein is a method, using an information technology system, to increase the likelihood of obtaining a successful match for users of online dating sites. The invention provides a live-action videoconferencing atmosphere in which the software component of the invention selects potential matches based upon certain criteria specified by each user and upon the attributes listed on the users' online profiles. The software component of the invention creates an “affinity group” comprising users who both have the criteria sought by other users of the affinity group and who seek persons with attributes found in the other users of the affinity group. The software component of the invention then “pairs off” the users of the affinity group for one-on-one videoconferencing sessions where the “paring-off” is determined by an algorithm which evaluates the attributes/criteria of the users and attempts to create potential matches among the users of the affinity group. The invention allows each user of the affinity group to so interact with a number of other users of the affinity group and then allows the users to rank the users they have just met according to a scale indicative of their level of interest in a future meeting with the ranked user. The invention then may take certain steps to allow two users interested in each other to meet online at some future point. Finally, the invention may be modified for other online communities for purposes such as business networking, career networking, or social interaction.

### CROSS REFERENCE TO RELATED APPLICATIONS

This nonprovisional patent application claims the benefit of the filing date of provisional application No. 60/621,817, filed Oct. 25, 2004, which is herein incorporated by reference.

### STATEMENT REGARDING FEDERALLY SPONSORED RESEARCH AND DEVELOPMENT

No Federally sponsored research or development was requested for, accepted, or used in the development related to the invention herein claimed.

### BACKGROUND OF THE INVENTION

Numerous “online dating” websites exist on the internet, including such well-known sites as www.eHarmony.com, www.Match.com, and www.uDate.com. These websites generally involve a user creating an “online profile” in which said user lists his/her interests, physical description, and the desired characteristics of the user's potential “match.” These websites provide methods by which its users may interact with each other, the most common of which is a form of email. These websites may also implement an “active matching process” in which the computer systems operating the sites may examine user profiles and attempt to select potential matches for the searching user. This active matching process proceeds by evaluating the attributes of the searching user and what the searching user seeks in a match and then picking potential matches from the pool of other users by comparing the attributes and characteristics of the pool of other users against the searching user's attributes and desired characteristics in a partner.

Although these websites allow users to post their attributes and what they seek in a “match” and may implement an active matching process, they lack the spontaneity of live “networking” or “matchmaker” events. Furthermore, as the communication systems of these websites generally involve a process akin to email, the interaction between users lacks the atmosphere of live conversation. For this reason, users of these websites might find that a potential match, who may appear desirable from their posted profile, may not be as desirable as initially perceived because the two lack the “chemistry” between two people who interact in a live setting.

### SUMMARY OF THE INVENTION

The invention described and claimed herein is a method for increasing the likelihood of obtaining a successful match for users of online dating sites and a system comprised of information technology components for implementing said method.

The method is comprised of steps in which a set of users of an online community, such as an online dating site, are selected from the total pool of users based on certain criteria (the “affinity group”). The members of the affinity group are then invited to participate in an online videoconferencing event. The members of the affinity group are then paired off with potential interests for “one-on-one” videoconferencing. After each videoconference, the members of the affinity group may rank the person that he/she had just videoconferenced with according to the interest that he/she has in further contact. Finally, if two members of the affinity group had given each other high interest rankings, they may be given the option to immediately videoconference again after the termination of the videoconferencing event.

### DETAILED DESCRIPTION OF THE INVENTION

The invention consists of a “fast track” method in which a plurality of users of an online dating website, or a website such as a business networking, career oriented website, or any type of online community in which a plurality of users may join for mutual interests (hereinafter called the “Website”), may get acquainted with each other in a short period of time. The invention further consists of an information technology system (the “IT System”) implementing the method, where the IT System may be constructed from “off the shelf” information technology components and software. Those skilled in the arts of software development, information technology hardware, and networking systems will be able to construct a system implementing the disclosed method according to their specific requirements. The IT System may be implemented as part of the information technology system hosting and operating the Website, or it may be a separate system operated by another entity which has been retained as a partner or subcontractor by the entity operating the Website.

In addition to the benefit of allowing a plurality of users of the Website to meet a number of potentially interesting users in a short period of time, the invention has the benefit of using an algorithm to select an “affinity group” of users of the Website who are likely to have characteristics desirable to other members of the affinity group. This will result in a benefit in that the members of the affinity group will, in a step to be described below, be paired off with other users who are more likely to have the characteristics they seek in a potential “match,” thereby increasing the likelihood in the users successfully finding another user desirable to them. This algorithm will be implemented in the software component of the IT System.

The aforementioned affinity group will consist of two sets of users; in the example of an online dating site, one set will consist of males, while the other will consist of females (although other types of sets for the affinity group may be chosen depending on the sexual orientation of the various users of the example online dating site implementing the invention). The algorithm will select the affinity group based upon comparing the characteristics of the members of each set with the desirable characteristics sought in potential “matches” for the members of each set. For example, the members of each set may be selected on the basis of their physical location, their age, and their past success using the invention as implanted on the Website. As another example, the set of male users chosen for the first set of the affinity group may be dark-haired males with athletic builds seeking women with blonde hair and slim physiques, while the set of female users chosen for the second set of the affinity group may be blonde-haired, slim females seeking men with dark hair and athletic builds. As the algorithm will select both sets of the affinity group based upon the users' characteristics and the characteristics the users seek in a potential “match,” the algorithm will increase the likelihood that each user will, in a later step described below, be paired with a user possessing the characteristics that they are seeking, and that each user will likewise possess the characteristics sought by the user with whom they are paired with.

The algorithm may be designed, and subsequently coded as software, so that the set of user characteristics it compares includes, but is not limited to, physical characteristics (e.g. height, build, hair color), age, location of residence, interests, lifestyle attributes, ethnic and religious backgrounds, and career attributes (e.g. income, type of job, etc.). The algorithm may also be devised, and subsequently coded, to create a “hierarchy” of characteristics for the users of each set. This hierarchy consists of a“ranking” of the various characteristics in order of importance to the user; for example, if a user places more emphasis upon the physique of a potential partner, the algorithm would create a hierarchy where physique ranks ahead of other characteristics. In the final ranking of users in a set, two potential matches with similar characteristics would be ranked according to which had the better “physique” score according to the hierarchy of characteristics created by the algorithm according to the user's preferences.

After selecting the affinity group, the IT System will send an electronic notice, such as by email, to the members of the affinity group, inviting them to participate in a videoconferencing session (hereinafter referred to as the “Session”), the date and time of which should be set by the IT System (such as by an automated scheduling program) or by the administrators of the online community. The videoconferencing session may be set for a specific amount of time, such as one hour, to which the members of the affinity group should commit to attend. The users of the affinity group will then reply to the IT System with confirmation that they will participate in the Session.

As an alternative to the step of selecting the affinity group and sending notice to its members, the IT System may provide via the Website a list of upcoming sessions and allow the users to “browse” the sessions and electronically submit their interest in joining their selected session. After a number of users have submitted their interest, the IT System will then build the affinity group out of the users who have indicated their interest in joining a specific upcoming session.

Prior to participating in the Session, the users of the affinity group should ensure that their videoconferencing hardware, typically a “web-cam,” is functioning properly. This pre-Session preparation will ensure that the Session proceeds smoothly and that the users will not lose time during the Session due to technical difficulties. Although it is foreseen that the affinity group users will provide their own computer hardware and their own “web-cam” hardware, the invention can be applied in situations where the entity operating the Website will provide the hardware, such as a situation where the entity operating the Website holds a “promotion” event for marketing purposes. In this situation, the entity operating the Website may choose to provide the invention in a physical location in order to promote its service to new users (or existing users) by allowing them to participate in sessions during the promotion event.

At the scheduled time for the Session, the users of the affinity group who have confirmed that they will attend the Session login to the Session via the Website. A brief “set-up” period may commence, during which the IT System checks to ensure that the videoconferencing hardware of the users is functioning properly with the IT System and during which the Website or IT System may offer instructions and/or suggestions to the users as to how to make the most of their experience during the Session.

After the set-up period, the IT System will begin to “pair-off” the users of the affinity group. The IT System will pair-off one user from the first set with another user from the second set for a sub-Session, which consists of a “one-on-one” videoconference between the two users. All sub-Sessions of the Session will be of equal length, e.g., a one-hour session may be divided into twenty sub-Sessions of three minutes each. The total number of sub-Sessions may be pre-set, as in the case of a large affinity group in which the-users of each set will meet only a plurality of the users in the other set, or may be determined from the total size of the affinity group. The pairing-off of the users is performed by the software of the IT System, which may use the aforementioned algorithm to pre-select which users each user should be paired-off with, and which may also choose the order in which the pairings should occur. The software of the IT System could also arrange the Session so that each user of the first set of the affinity group will be offered a chance to be paired-off with each user of the second set of the affinity group, i.e., if the affinity group consists of two sets of fifteen users each, the IT System divide a one-hour Session into fifteen sub-Sessions of four minutes each.

During the sub-Session, the two users may begin a one-on-one conversation using their video conferencing hardware. A “fall-back” system may be incorporated into the invention in which the users will use voice over IP (“VoIP”), instant messaging, or “chat” software in the event that a technical malfunction prevents the use of their videoconferencing hardware during or prior to the Session. The IT System can also provide each user's Website profile, or other information the user had previously submitted to the Website, on each user's screen so that the two users will have “talking points” with which to initiate conversation in order to “break the ice” after being introduced to the new user. The IT System can also provide video clips, such as commercials for third-party products or “infomercials,” which will be played on the users' computer screens while they wait for the Session to start, while they wait during time breaks between the sub-Sessions, or during “down time” resulting from technical difficulties or the time lags caused by low bandwidth availability.

At the conclusion of the sub-Session, the IT System will automatically disconnect the two users. Each user will then be presented with an electronic scorecard where they can “rank” the other user according to a ranking system. The ranking system may consist of a simple “0-10” rating scale, where a “0” indicates “no interest” and a “10” indicates a “very interested.” The ranking system may also include a plurality of different “scales,” for which each user may rate the other on a number of parameters, and then submit to the IT System. As an alternative, the electronic scorecard may consist of the options of “Yes,” “No,” and “Maybe” as answers the users provide to a query by the IT System asking if the user would be interested in meeting the other user again.

After the rankings have been submitted, the IT System will then pair-off each user of the first set of the affinity group with another user of the second set of the affinity group. Again, the IT System may choose the user-to-user pairings based upon the aforementioned algorithm programmed into the IT System's software. The two users will then begin a new sub-Session, at the conclusion of which they again rate each other as described above. The IT System will continue to automatically connect and disconnect the users of each set of the affinity group for the sub-Sessions until the Session time has expired.

When the Session has ended, the software of the IT System will calculate and compare the rankings that each user has' submitted for each user that he/she met during the videoconferenced sub-Sessions. The IT System will, for each user, list the other users that the user “met” according to their score. The IT System may optionally reveal to the user the ranking score he/she received from the users he/she videoconferenced with during the sub-Sessions.

In the above described ranking calculation/comparison step, if the IT System uses the simple “0-10” ranking system, it will simply rank the users using the “0-10” score each user submitted for the users he/she had met. If the IT System is configured to use the aforementioned “scales,” in which each user may rate another on a number of different parameters, the software of the IT System may be coded with an algorithm that evaluates a final “score” based upon the aforementioned scales using a pre-designated weight for each parameter in order to calculate a weighted average, which is then presented as the final score. This algorithm may also incorporate rankings of the users as submitted by other users as calculated after prior sessions in which the ranked user had participated. These “third-party” scores may also be presented to the user so that the user may discern what other users had rated the affinity group users in prior sessions. The IT System will also store the final ranking information for other possible services or possibly “pattern recognition” to ascertain any patterns in the final data, e.g., discerning that a user is ranked higher by a particular type of other user.

After the end of the Session and after the ranking calculations have been completed, the IT System may also offer two users the option to videoconference again if each user had given the other a very high ranking score; thus, two users of an affinity group who rated each other a “10” may be given the option to further use the IT System for a post-Session one-on-one videoconference. The software of the IT System may also be configured to use the “Yes/No/Maybe” scorecard and to evaluate the “past history” of the users to determine if certain users should be given the option for the post-Session one-on-one videoconferencing (e.g., if a first user chose another via a “Yes” reply, and the designated user also chose the first user with a “Yes” reply, the first user would be given precedence to meet the designated user over another user of the same set as the first user if the first user had no success during past sessions while the other user was successful).

After the optional post-Session “one-on-one” step described above, the IT System will include such steps as: allowing users to exchange email addresses, names, or other information with users to which they gave high final rankings and received high final rankings; allowing users to express interest in exchanging information with other users met during the Session; and/or allowing users to schedule future videoconferencing sessions with other users met during the Session. The IT System can also choose a “match” for the user based upon the final rankings of the user and of the potential match. The IT System can then use. an electronic calendar to “track” the matched pair and remind them via electronic messages that they should “follow up” the Session by contacting each other. The IT System can also send electronic invites to users who had an unsuccessful Session to participate in a future session. The IT System and Website may also be configured to include an “event history” section on the Website which indicates which other users chose the selected user after past sessions, including a hypertext link to the online profiles of the choosing users.

As described herein, the preferred embodiment of the invention is its application to online “dating” or “personals” sites, but those versed in the arts referenced herein may find other types of online communities or websites to which the invention may be applied. Other examples of the application of the invention include use of the invention for online career networking, such as holding a session in which business representatives meet to create business contacts, in social networking websites such as LinkedIn.com, and in online “employment” websites for the interview of potential job applicants.

What is claimed is:

1. A method of increasing the likelihood of a first group of users of an online community meeting sought-after members of a second group of users of said online community in which the members of said second group of users possesses characteristics desired by members of said first group of users, and where members of said first group of users possess characteristics desired by members of the said second group of users, comprising the steps of:
designating an initial affinity group of users of said. online community in which said initial affinity group of users is to consist of a first set of users and a second set of users, wherein said first set of users is to consist of users from said first group of users and wherein said second set of users is to consist of users from said second group of users;
selecting members of said initial affinity group of users from said first group of users and said second group of users based upon a comparison of the characteristics of said first group of users to the characteristics of said second group of users, where after such comparison, the members of said initial affinity group are selected so that said first set of users consists of users with characteristics sought by users of said second set of users and said second set of users consists of users with characteristics sought by users of said first set of users;
delivering a notice to said initial affinity group of users inviting said initial affinity group of users to a conferencing session, said conferencing session to be divided into a plurality of sub-sessions, and receiving responses from the users of said initial affinity group indicating their desire to participate in said conferencing session;
building a final affinity group consisting of the users of said initial affinity group who have indicated an interest in participating in said conferencing session, said final affinity group consisting of the users of said first set of users and said second set of users who have indicated an interest in participating in said conferencing session;
placing each user of said first set of users into an interactive setting, using said conferencing computer hardware and software, with a user of said second set of users for the duration of one of said conferencing sub-sessions, in which the placement is determined according to a pairing methodology;
allowing the users, upon the conclusion of their said conferencing sub-session, to submit a rating of the user with whom they had interacted with in their said conferencing sub-session according to a ranking scale;
placing each user of said first set of users in a subsequent interactive setting, using said conferencing computer hardware and software, with another user of said second set of users for the duration of one of said conferencing sub-sessions, in which the placement is determined according to a pairing methodology, thereupon allowing each user, upon the conclusion of their subsequent sub-session, to rate the user with whom they had interacted with in said subsequent conferencing sub-session according to a ranking scale, and continuing this step until said conferencing session has ended;
calculating a final rank of the users with whom each user was paired during said conferencing session, said final rank calculated from said ratings submitted by each user according to said ranking scale;
presenting the final rankings of the users with whom each user was paired during said conferencing session to the user who had submitted said ratings, including the optional sub-step of presenting the user's rating, as calculated by the users with whom the user was paired during said conferencing session, to the user;
optionally allowing two users who had been paired during said conferencing session to initiate a new conferencing session if said two users who had been paired during said conferencing session submitted high ratings;
allowing users to submit an indication of interest in meeting a plurality of the users with whom each user was paired during said conferencing session;
optionally allowing users to schedule future meetings with any one of the plurality of the users with whom each user was paired during said conferencing session; and
optionally notifying users not pleased with the users with whom they had been paired of future conferencing sessions.

2. The method of claim 1, wherein said online community is selected from the group: an online community formed for the purpose of online dating, an online community formed for the purpose of business networking, an online community formed for the purpose of matching job seekers with potential employers, an online community formed for the purpose of social networking, and an online community formed for the purpose of social interaction.

3. The method of claim 1, wherein said pairing methodology is selected from the group: randomly selecting users to whom the user is to be paired, and selecting users to whom the user is to be paired according to an evaluation of the characteristics of the user and the users to whom the user is to be paired.

4. The method of claim 1, wherein said characteristics of the users are selected from the group: physical characteristics, age, location of residence, interests, lifestyle attributes, ethnic and religious backgrounds, and career attributes.

5. The method of claim 1, wherein said conferencing computer hardware and software is selected from the group: videoconferencing hardware and software, audio conferencing hardware and software, and voice over internet protocol hardware and software.

6. The method of claim 1, wherein said ranking scale is selected from the group: a “Yes/No/Maybe” ranking scale, a ranking scale of the integers 0 to 10, and a ranking scale based upon a plurality of sub-scales ranking the evaluated user according to a set of criteria which may include the characteristics of the ranked user.

7. The method of claim 1, wherein said final rank of each user is calculated using the additional criteria of rankings submitted by other users who had evaluated the ranked user during past conferencing sessions and wherein said rankings submitted by other users is presented to the user.

8. The method of claim 1, wherein said indication of interest may be an indication that the user wishes to exchange email addresses, names or other information.

9. A system of information technology components, comprising computer hardware, software, and networking equipment, in which said information technology components interact with or host an online community comprised of a first group of users and a second group of users, where the members of said second group of users possesses characteristics desired by members of said first group of users, and where members of said first group of users possess characteristics desired by members of the said second group of users, in which:
said information technology components designate an initial affinity group of users of an online community in which said initial affinity group of users is to consist of a first set of users and a second set of users, wherein said first set of users is to consist of users from said first group of users and wherein said second set of users is to consist of users from said second group of users;
said information technology components select members of said initial affinity group of users from said first group of users and said second group of users based upon a comparison of the characteristics of said first group of users to the characteristics of said second group of users, where after such comparison, the members of said initial affinity group are selected so that said first set of users consists of users with characteristics sought by users of said second set of users and said second set of users consists of users with characteristics sought by users of said first set of users;
said information technology components deliver a notice to said initial affinity group of users inviting said initial affinity group of users to a conferencing session, said conferencing session to be divided into a plurality of sub-sessions, and receiving responses from the users of said initial affinity group indicating their desire to participate in said conferencing session;
said information technology components build a final affinity group consisting of the users of said initial affinity group who have indicated an interest in participating in said conferencing session, said final affinity group consisting of the users of said first set of users and said second set of users who have indicated an interest in participating in said conferencing session;
said information technology components place each user of said first set of users into an interactive setting, using said conferencing computer hardware and software, with a user of said second set of users for the duration of one of said conferencing sub-sessions, in which the placement is determined according to a pairing methodology;
said information technology components allow the users, upon the conclusion of their said conferencing sub-session, to submit a rating of the user with whom they had interacted with in their said conferencing sub-session according to a ranking scale;
said information technology components place each user of said first set of users in a subsequent interactive setting, using said conferencing computer hardware and software, with another user of said second set of users for the duration of one of said conferencing sub-sessions, in which the placement is determined according to a pairing methodology, thereupon allowing each user, upon the conclusion of their subsequent sub-session, to rate the user with whom they had interacted with in said subsequent conferencing sub-session according to a ranking scale, and continuing this step until said conferencing session has ended;
said information technology components calculate a final rank of the users with whom each user was paired during said conferencing session, said final rank calculated from said ratings submitted by each user according to said ranking scale;
said information technology components present the final rankings of the users with whom each user was paired during said conferencing session to the user who had submitted said ratings, including the optional sub-step of presenting the user's rating, as calculated by the users with whom the user was paired during said conferencing session, to the user;
said information technology components optionally allow two users who had been paired during said conferencing session to initiate a new conferencing session if said two users who had been paired during said conferencing session submitted high ratings;
said information technology components allow users to submit an indication of interest in meeting a plurality of the users with whom each user was paired during said conferencing session;
said information technology components optionally allow users to schedule future meetings with any one of the plurality of the users with whom each user was paired during said conferencing session; and
said information technology components optionally notify users not pleased with the users with whom they had been paired of future conferencing sessions.

10. A method of increasing the likelihood of a first group of users of an online community meeting sought-after members of a second group of users of said online community in which the members of said second group of users possesses characteristics desired by members of said first group of users, and where members of said first group of users possess characteristics desired by members of the said second group of users, comprising the steps of:
allowing users to indicate their interest in participating in a conference session by electronic means;
designating a final affinity group consisting of the users who have indicated their desire to participate in said conferencing session, said final affinity group to consist of a first set of users and a second set of users, wherein said first set of users is to consist of users from said first group of users and wherein said second set of users is to consist of users from said second group of users;
placing each user of said first set of users into an interactive setting, using said conferencing computer hardware and software, with a user of said second set of users for the duration of one of said conferencing sub-sessions, in which the placement is determined according to a pairing methodology;
allowing the users, upon the conclusion of their said conferencing sub-session, to submit a rating of the user with whom they had interacted with in their said conferencing sub-session according to a ranking scale;
placing each user of said first set of users in a subsequent interactive setting, using said conferencing computer hardware and software, with another user of said second set of users for. the duration of one of said conferencing sub-sessions, in which the placement is determined according to a pairing methodology, thereupon allowing each user, upon the conclusion of their subsequent sub-session, to rate the user with whom they had interacted with in said subsequent conferencing sub-session according to a ranking scale, and continuing this step until said conferencing session has ended;
calculating a final rank of the users with whom each user was paired during said conferencing session, said final rank calculated from said ratings submitted by each user according to said ranking scale;
presenting the final rankings of the users with whom each user was paired during said conferencing session to the user who had submitted said ratings, including the optional sub-step of presenting the user's rating, as calculated by the users with whom the user was paired during said conferencing session, to the user;
optionally allowing two users who had been paired during said conferencing session to initiate a new conferencing session if said two users who had been paired during said conferencing session submitted high ratings;
allowing users to submit an indication of interest in meeting a plurality of the users with whom each user was paired during said conferencing session;
optionally allowing users to schedule future meetings with any one of the plurality of the users with whom each user was paired during said conferencing session; and
optionally notifying users not pleased with the users with whom they had been paired of future conferencing sessions.

11. The method of claim 10, wherein said online community is selected from the group: an online community formed for the purpose of online dating, an online community formed for the purpose of business networking, an online community formed for the purpose of matching job seekers with potential employers, an online community formed for the purpose of social networking, and an online community formed for the purpose of social interaction.

12. The method of claim 10, wherein said pairing methodology is selected from the group: randomly selecting users to whom the user is to be paired, and selecting users to whom the user is to be paired according to an evaluation of the characteristics of the user and the users to whom the user is to be paired.

13. The method of claim 10, wherein said characteristics of the users are selected from the group: physical characteristics, age, location of residence, interests, lifestyle attributes, ethnic and religious backgrounds, and career attributes.

14. The method of claim 10, wherein said conferencing computer hardware and software is selected from the group: videoconferencing hardware and software, audio conferencing hardware and software, and voice over internet protocol hardware and software.

15. The method of claim 10, wherein said ranking scale is selected from the group: a “Yes/No/Maybe” ranking scale, a ranking scale of the integers 0 to 10, and a ranking scale based upon a plurality of sub-scales ranking the evaluated user according to a set of criteria which may include the characteristics of the ranked user.

16. The method of claim 10, wherein said final rank of each user is calculated using the additional criteria of rankings submitted by other users who had evaluated the ranked user during past conferencing sessions and wherein said rankings submitted by other users is presented to the user.

17. The method of claim 10, wherein said indication of interest may be an indication that the user wishes to exchange email addresses, names or other information.

18. A system of information technology components, comprising computer hardware, software, and networking equipment, in which said information technology components interact with or host an online community comprised of a first group of users and a second group of users, where the members of said second group of users possesses characteristics desired by members of said first group of users, and where members of said first group of users possess characteristics desired by members of the said second group of users, in which:
said information technology components allow users to indicate their interest in participating in a conference session by electronic means;
said information technology components designate a final affinity group consisting of the users who have indicated their desire to participate in said conferencing session, said final affinity group to consist of a first set of users and a second set of users, wherein said first set of users is to consist of users from said first group of users and wherein said second set of users is to consist of users from said second group of users;
said information technology components place each user of said first set of users into an interactive setting, using said conferencing computer hardware and software, with a user of said second set of users for the duration of one of said conferencing sub-sessions, in which the placement is determined according to a pairing methodology;
said information technology components allow the users, upon the conclusion of their said conferencing sub-session, to submit a rating of the user with whom they had interacted with in their said conferencing sub-session according to a ranking scale;
said information technology components place each user of said first set of users in a subsequent interactive setting, using said conferencing computer hardware and software, with another user of said second set of users for the duration of one of said conferencing sub-sessions, in which the placement is determined according to a pairing methodology, thereupon allowing each user, upon the conclusion of their subsequent sub-session, to rate the user with whom they had interacted with in said subsequent conferencing sub-session according to a ranking scale, and continuing this step until said conferencing session has ended;
said information technology components calculate a final rank of the users with whom each user was paired during said conferencing session, said final rank calculated from said ratings submitted by each user according to said ranking scale;
said information technology components present the final rankings of the users with whom each user was paired during said conferencing session to the user who had submitted said ratings, including the optional sub-step of presenting the user's rating, as calculated by the users with whom the user was paired during said conferencing session, to the user;
said information technology components optionally allow two users who had been paired during said conferencing session to initiate a new conferencing session if said two users who had been paired during said conferencing session submitted high ratings;
said information technology components allow users to submit an indication of interest in meeting a plurality of the users with whom each user was paired during said conferencing session;
said information technology components optionally allow users to schedule future meetings with any one of the plurality of the users with whom each user was paired during said conferencing session; and
said information technology components optionally notify users not pleased with the users with whom they had been paired of future conferencing sessions.
